(19) United States
(12) Patent Application Publication
(10) Pub. No.: US 2023/0199015 A1
(43) Pub. Date: Jun. 22, 2023

(54) SYSTEM AND METHOD FOR CONTEXTUAL MISCONFIGURATION DETECTION

(71) Applicant: NONAME GATE LTD, Tel Aviv-Yafo (IL)

(72) Inventors: Shay LEVI, Tel Aviv (IL); Oz GOLAN, Ramat Gan (IL); Hila ZIGMAN, Ramat Gan (IL); Oren SHPIGEL, Tel Aviv (IL); Netanel MAMAN, Mazkeret Batia (IL); Yuval ALKALAI, Ramat Gan (IL); Dor DANKNER, Tel Aviv (IL)

(73) Assignee: NONAME GATE LTD, Tel Aviv-Yafo (IL)

(21) Appl. No.: 17/645,165

(22) Filed: Dec. 20, 2021

(51) Int. Cl. H04L 9/40

(52) U.S. Cl. CPC H04L 63/1433; H04L 63/20

(57) ABSTRACT

A system and method for contextual misconfiguration detection. A method includes identifying at least one configuration parameter based on configuration data related to a computing interface; determining at least one traffic behavior based on traffic data of traffic to and from the computing interface; and detecting at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior.

### TECHNICAL FIELD

The present disclosure relates generally to misconfiguration detection, and more specifically to detecting misconfigurations based on configuration data with contextual traffic data.

### BACKGROUND

The vast majority of cybersecurity breaches can be traced back to an issue with a computer interface such as an application programming interface (API). API abuses are expected to become the most frequent attack vector in the future, and insecure APIs have been identified as a significant threat to cloud computing.

An API is a computing interface. A computing interface is a shared boundary across which two or more separate components of a computer system exchange information. Computing interfaces therefore allow disparate computing components to effectively communicate with each other despite potential differences in communication format, content, and the like. An API defines interactions between software components.

Misconfigurations in computing interfaces expose security vulnerabilities which can lead to data breaches. It is therefore critical to monitor for misconfigurations. Existing solutions defining misconfigurations too narrowly tend to lead to many false negatives, while solutions defining misconfigurations too broadly tend to lead to many false positives.

Additionally, defining misconfigurations based on certain observed activities for the computing interface does not allow for effective prevention of cybersecurity attacks. More specifically, solutions which detect misconfiguration based on activities related to consuming computing interfaces will only detect misconfigurations after a malicious service has already attempted to consume the computing interface. As a result, such solutions may fail to stop or otherwise mitigate the malicious activity until after the malicious activity has already begun or is completed.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for contextual misconfiguration detection. The method comprises: identifying at least one configuration parameter based on configuration data related to a computing interface; determining at least one traffic behavior based on traffic data of traffic to and from the computing interface; and detecting at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior.

Certain embodiments disclosed herein also include a non-transitory computer readable medium having stored thereon causing a processing circuitry to execute a process, the process comprising: identifying at least one configuration parameter based on configuration data related to a computing interface; determining at least one traffic behavior based on traffic data of traffic to and from the computing interface; and detecting at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior.

Certain embodiments disclosed herein also include a system for contextual misconfiguration detection. The system comprises: a processing circuitry; and a memory, the memory containing instructions that, when executed by the processing circuitry, configure the system to: identify at least one configuration parameter based on configuration data related to a computing interface; determine at least one traffic behavior based on traffic data of traffic to and from the computing interface; and detect at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIGS. 1A-1C are network diagrams utilized to describe various disclosed embodiments.

FIG. 2 is a flowchart illustrating a method for contextual misconfiguration detection according to an embodiment.

FIG. 3 is a flowchart illustrating a method for duplicating traffic according to an embodiment.

FIG. 4 is a schematic diagram of a misconfiguration detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In light of the challenges noted above, it is noted that existing solutions for detecting misconfigurations in computing interfaces such as Application Programming Interfaces (APIs) typically detect misconfigurations when a service attempts to consume the computing interface. However, as noted above, only detecting misconfigurations after the service has already attempted to consume the service may result in failing to detect misconfigurations in time to protect the appropriate computing assets. Specifically, when misconfigurations are detected as a service attempts to consume a computing interface, either an alert is generated too late to stop the threat or a false positive may be detected.

Further, it has been identified that various traffic behaviors of a computing interface may be benign when the computing interface is configured in some ways and may introduce security vulnerabilities when the computing interface is configured in other ways. Accordingly, the disclosed embodiments consider traffic behavior in combination with configuration in order to determine whether a particular configuration leaves a computing interface vulnerable in context with respect to the traffic going into and out of the computing interface. Using traffic behavior in combination with configurations allows for improving accuracy of misconfiguration detection at least as compared to rules which define misconfigurations in terms of either configuration parameters or traffic behavior alone.

To this end, the disclosed embodiments include techniques for detecting misconfigurations in computing interfaces that utilize traffic behavior with respect to computing interfaces in combination with configurations of those computing interfaces in order to detect contextual misconfigurations as combinations of certain traffic behaviors and certain configuration parameters. The disclosed embodiments therefore utilize traffic behavior of a computing interface in order to add context regarding the configuration of a computing interface (and vice versa) in order to provide more granular data than using the configuration parameters or traffic behavior alone.

The various disclosed embodiments include systems and methods for contextual misconfiguration detection. Configuration data for a computing interface is analyzed in order to identify one or more predetermined traffic-related configuration parameters of the computing interface. Traffic data to and from the user interface is analyzed in order to determine one or more traffic behaviors of the computing interface. One or more contextual misconfiguration detection rules is applied to the traffic-related configuration parameters and the traffic behaviors in order to detect one or more misconfigurations of the computing interface. The contextual misconfiguration detection rules define each misconfiguration as a combination of one or more configuration parameters and one or more traffic behaviors such that misconfigurations are defined contextually with respect to traffic behavior relative to a given configuration.

The disclosed embodiments allow for improving accuracy of misconfiguration detection, reducing false positives, and detecting misconfigurations earlier. In particular, some embodiments allow for proactively checking traffic behaviors in order to identify contextual misconfigurations prior to runtime. Consequently, the disclosed embodiments also allow for taking actions with respect to misconfigurations in order to prevent or otherwise mitigate threats realized as services before those services actually attempt to consume a computing interface. Moreover, the disclosed embodiments may be utilized to provide more specific misconfiguration information, which in turn can be utilized to improve mitigation actions by allowing for more accurate selection of appropriate mitigation actions based on the combined traffic and configuration data.

Additionally, the disclosed embodiments utilize rules defining certain combinations of configuration parameters and traffic behaviors that provide an objective, rules-based process for detecting misconfigurations using context. Such an objective process provides more consistent results than manual observation of contexts related to configurations. In this regard, it is noted that manual detection of misconfigurations would rely on subjective judgments regarding whether a given traffic behavior “feels” unusual or otherwise indicative of a misconfiguration in light of the configuration of the computing interface. Thus, the disclosed embodiments allow for automating misconfiguration detection in a manner that improves accuracy as compared to existing automated misconfiguration detection solutions while maintaining consistency as compared to manual misconfiguration detection solutions.

The disclosed embodiments further include techniques for duplicating traffic in order to aid in contextual misconfiguration detection. Specifically, traffic may be duplicated in order to provide complete traffic data, particularly for intra-organization traffic which may otherwise be inaccessible using existing traffic mirroring solutions.

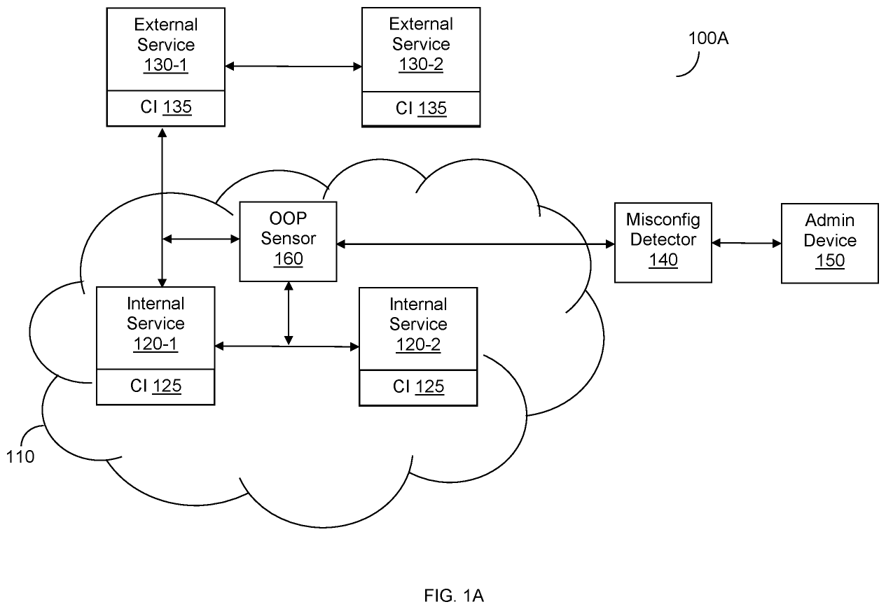

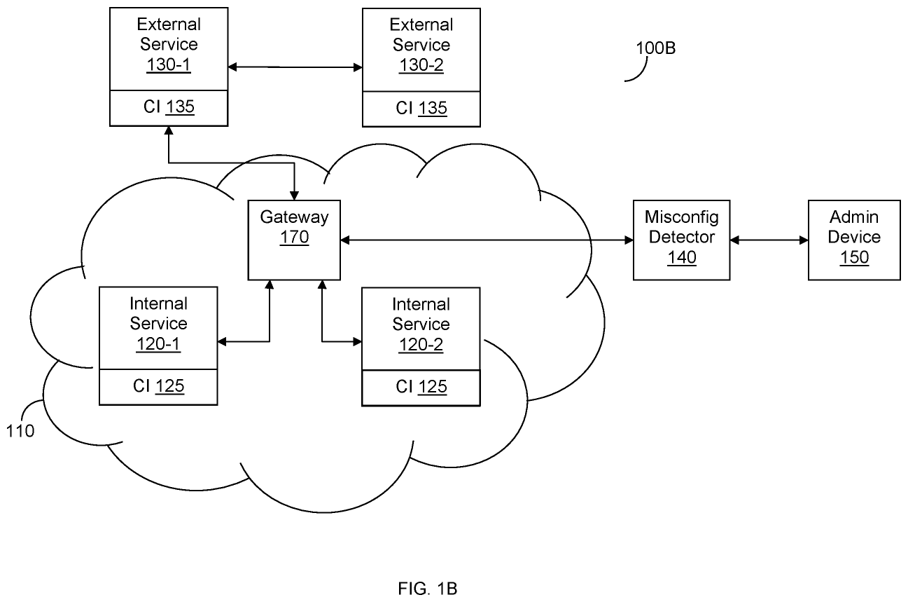

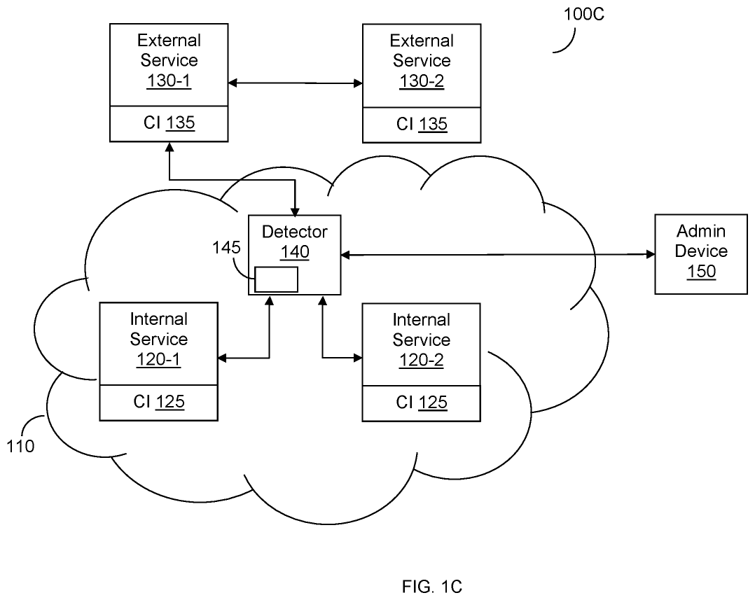

FIGS. 1A-C show example network diagrams 100A-C utilized to describe various disclosed embodiments. In each of FIGS. 1A-C, internal services 120-1 and 120-2 (which may be referred to individually as an internal service 120 or collectively as internal services 120) communicate with each other and/or with external services 130-1 and 130-2 (which may be referred to individually as an external service 130 or collectively as external services 130). The internal services 120-1 and 120-2 are services hosted on a network 110. Each of the internal services 120 communicates at least using a respective communications interface (CI) 125 and each of the external services 130 communicates at least using a respective communications interface (CI) 135. The communication interfaces 125 and 135 may be, but are not limited to, Application Programming Interfaces (APIs).

The network 110 may be, but is not limited to, a wireless, cellular or wired network, a local area network (LAN), a wide area network (WAN), a metro area network (MAN), the Internet, the worldwide web (WWW), similar networks, and any combination thereof. The network 110 may be operated by an organization (e.g., by including servers owned by the organization), or may be operated by another entity (e.g., a cloud provider or other provider of network computing services). It should be noted that a single network 110 is depicted merely for simplicity purposes, but that the internal services 120 may communicate via multiple networks and/or other connections in accordance with the disclosed embodiments.

FIG. 1A depicts an out of band implementation. In FIG. 1A, an out of path (OOP) sensor 160 is deployed out of path of the communicating services 120 and 130. In an example implementation, the out of path sensor 160 is configured to duplicate computing interface traffic between the computing interfaces 125 and/or 135, and to send the duplicated traffic to the misconfiguration detector 140 for analysis.

FIG. 1B depicts a gateway plugin implementation. In FIG. 1B, a gateway 170 is deployed in line between the internal services 120 and between the internal service 120-1 and the external services 130-1. The gateway 170 may be, but is not limited to, an API gateway. The gateway 170 is configured to receive requests and responses from any of the services 120 and/or 130, and to forward those requests and responses to appropriate destinations. The gateway 170 may be further configured to enforce one or more policies with respect to traffic. In the example implementation shown in FIG. 1B, the gateway 170 is configured to send a copy of each request and response to the misconfiguration detector 140 for analysis. When the traffic between the computing interfaces 125 and/or 135 is encrypted, the gateway 170 may be further configured to decrypt the traffic data before transmitting such data to the misconfiguration detector 140.

FIG. 1C depicts an in line implementation. In FIG. 1C, the misconfiguration detector 140 is deployed in line between the internal services 120 and between the internal service 120-1 and the external services 130-1. The misconfiguration detector 140 is configured to analyze requests and responses as described herein in order to detect misconfigurations in the computing interfaces 125 and/or 135. To this end, the misconfiguration detector 140 may include a sensor module 145 configured to duplicate traffic as described herein. The misconfiguration detector 140 may be further configured to act as a gateway by forwarding requests and responses to appropriate destinations, decrypting traffic, or both.

The misconfiguration detector 140 is configured to detect computing interface misconfigurations as described herein, and may be configured to send data indicating the detected anomalies and/or the supplemental data to the admin device 150 for display.

It should be noted that the particular network configurations shown in FIGS. 1A-C are merely utilized to illustrate various example deployments of the misconfiguration detector 140 and that the disclosed embodiments may be applied to other network configurations without departing from the scope of the disclosure. As some particular examples, different numbers of internal services 120, external services 130, or both, may communicate amongst each other, and the misconfiguration detector 140 may be deployed such that it can identify anomalies in any or all such communications. In such implementations, multiple anomaly detectors may be utilized. Additionally, the misconfiguration detector 140 may be implemented as a system (e.g., a server), as a virtual machine, as a software container or other self-contained software package, and the like. Further, although the misconfiguration detector 140 is described in various embodiments as duplicating traffic, the misconfiguration detector 140 is not necessarily configured as such and traffic duplication may be performed by another system without departing from the scope of the disclosed embodiments.

It should also be noted that the misconfiguration detector 140 is depicted as outside of the organization's network 110 in FIGS. 1A-B merely for simplicity purposes, and that the particular location of deployment of the misconfiguration detector 140 may vary in at least some implementations. As non-limiting examples, the misconfiguration detector 140 may be realized as a software-as-a-service (SaaS) managed in a separate cloud environment from the network 110, via accessing a shared cloud account that is also accessible to systems of the network 110, or on premises (e.g., in the network 110 or otherwise in physical or network proximity to the services 120), and the like.

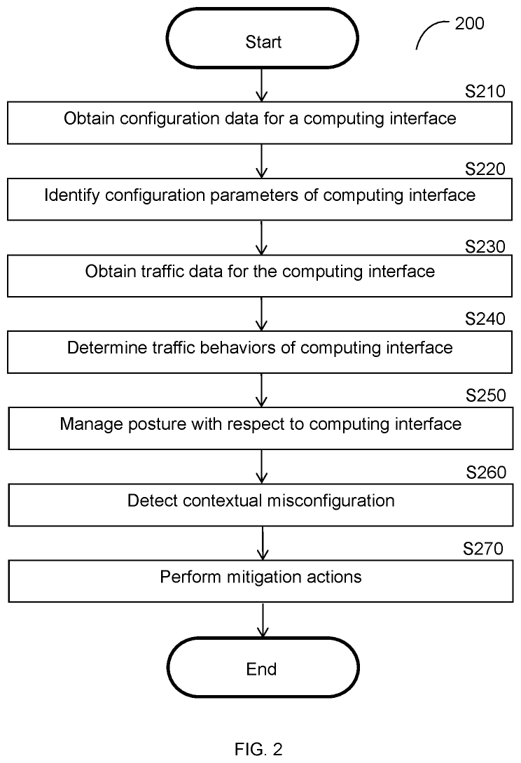

FIG. 2 is a flowchart 200 illustrating a method for contextual computing interface misconfiguration detection according to an embodiment. In an embodiment, the method may be performed by the misconfiguration detector 140, FIGS. 1A-C.

At S210, configuration data for a computing interface is obtained. The computing interface may be, but is not limited to, an application programming interface (API).

The configuration data may be retrieved from a configuration file of the computing interface. The configuration file may indicate configuration parameters indicating different characteristics of the configuration of the computing interface such as, but not limited to, whether the computing interface enforces or requires authentication, whether input validation is enabled, whether input sanitation is enabled, whether rate limiting is enabled, whether payload sizes are limited, whether the computing interface is permitted to consume unencrypted traffic, encryption algorithms used to encrypt traffic to or from the computing interface, combinations thereof, and the like.

Alternatively or in combination, the configuration data may be retrieved with respect to other systems, networks, or services accessible to the computing interface. Specifically, such configuration data may indicate, but is not limited to, networks or services to which the computing interface is exposed (e.g., an API having a direct route to the public Internet), whether the computing interface is available directly or via another communication component (e.g., a computing interface management service or application gateway through which the computing interface is accessible), whether a computing interface management service (e.g., an API management service) is accessible directly via a public network (e.g., the Internet), whether, a Web Application Firewall (WAF) is configured on an Application Gateway through which the computing interface is exposed (e.g., to the Internet), whether traffic to the computing interface is controlled via a load balancer, combinations thereof, whether a load balancer is configured with an Application Security Manager (ASM) module, configuration parameters of components communicating via the computing interface (e.g., whether an application gateway is configured with certain Distributed Denial of Service protection measures), combinations thereof, and the like.

At S220, the configuration data is analyzed to identify traffic-related configuration parameters of the computing interface. The configuration parameters may be identified as, for example, certain values in respective fields of the configuration data. To this end, S220 may include applying traffic-related configuration parameter identification rules that define traffic-related configuration parameters with respect to values of certain predetermined fields of configurations known to contain traffic-related configuration data.

At S230, traffic data is obtained for the computing interface. The computing interface traffic data includes traffic to and from the computing interface. To this end, the data may include, but is not limited to, requests and responses of calls to computing interfaces (i.e., requests sent as part of calls to computing interfaces and responses to those requests).

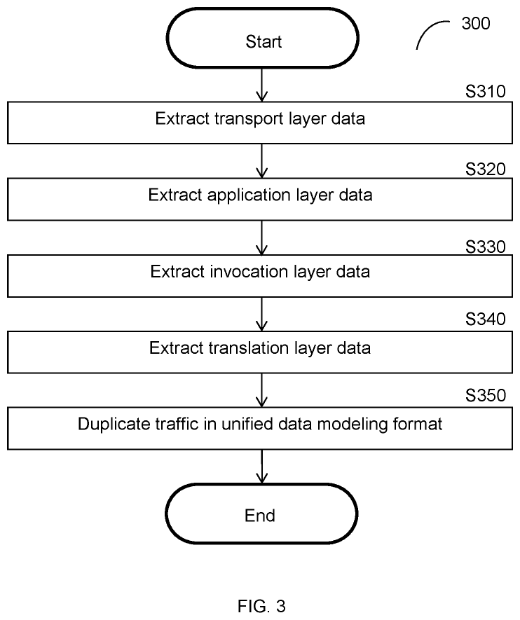

In an embodiment, the computing interface traffic data may include duplicated traffic. To this end, in some embodiments, S230 may further include duplicating traffic. A non-limiting example method demonstrating how such duplicated traffic may be obtained is described below with respect to FIG. 3. Such an example method may be utilized to effectively duplicate intra-organization traffic in order to provide access to traffic that would not otherwise be obtainable, thereby allowing for improving the accuracy of contextual misconfiguration detection as described herein using such newly obtainable data.

At S240, traffic behaviors of the computing interface are determined based on the traffic data. The traffic behaviors may be determined based on specific activities performed via the computing interface, statistical trends in computing interface traffic, both, and the like.

In an embodiment, S240 includes analyzing the traffic data to identify types of data including fields and values of interest among traffic to and from the computing interface. The analysis may include analysis of headers, bodies, query strings, path parameters, and other components of requests and responses.

The fields and values of interest are fields and values included in requests and responses of computing interface calls. These fields and values of interest are indicative of how the computing interface behaves vis-a-vis calls to the computing interface. The fields of interest indicate information included in the data such as, but not limited to, header information (e.g., channels by which data is communicated, protocols used for communicating data, communication method [e.g., POST], etc.), body information (e.g., email address, mailing address, social security number, phone number, etc.), combinations thereof, and the like. The values of interest include the actual data provided for those fields.

The analysis may further include statistically analyzing values with respect to fields in order to determine at least some of the traffic behaviors as statistical behaviors. These statistical behaviors may be defined with respect to information such as, but not limited to, whether values certain fields are normally included or populated in requests to and responses from the computing interface (e.g., whether an email field is normally included), data types of data normally used for values of respective fields (e.g., String, integer, etc.), whether certain fields are optional (i.e., the field is often included but not always), specific values for certain fields (e.g., either “authenticated” or “not authenticated”), combinations thereof, and the like. In this regard, it has been identified that trends in computing interface behavior can be analyzed statistically in order to establish behaviors for computing interfaces with respect to traffic. These statistically determined behaviors, in turn, may be utilized to determine whether a computing interface is misconfigured based on analysis of subsequent traffic to and from the computing interface.

In an embodiment, S240 may further include identifying the absence of certain fields, values, or both. As a non-limiting example, to determine authentication status (e.g., a data type which may have values of either “authenticated” or “not authenticated”), it may be determined whether some form of authentication credentials is included in requests such that, when such credentials are not included in a request, the absence of credentials (and, consequently, a lack of authentication) is identified.

In this regard, it is noted that certain behaviors may manifest as individual activities, but that some relevant traffic behaviors are reflected in statistical trends which may not be absolute (i.e., not all instances of traffic may reflect the trend but the majority or otherwise a substantial portion of the traffic instances reflect the trend). Accordingly, statistically analyzing traffic allows for unearthing new traffic behaviors that further improves granularity and accuracy of contextual misconfiguration detection when used during subsequent processing as described herein. The threshold for determining whether aggregate behavior is significant enough to be determined as a statistical behavior may vary depending on, for example, the field being analyzed.

At S250, a cybersecurity posture is managed at least with respect to the computing interface. The cybersecurity posture may be, but is not limited to, a posture of an environment (e.g., an environment including devices interacting in or with the network 110, FIGS. 1A-C) in which the computing interface is deployed. The posture is a model of at least the computing interfaces used for communications in or with a computing environment used to analyze the setup of the environment and its logical components with respect to cyber threats. To this end, S250 includes creating or updating the posture at least with respect to the computing interface.

In an embodiment, the posture managed at S250 is managed based on contextual data including both traffic-related configuration parameters and traffic behaviors for the computing interface (e.g., configuration parameters identified as described above with respect to S220 and traffic behaviors determined as described above with respect to S240). The posture of an environment defines the setup of the environment with respect to these configuration parameters and traffic behaviors, and may further define the setup of the environment with respect to internal communications between logical components of the environment.

In a further embodiment, S250 includes creating an inventory (e.g., creating a new inventory or updating an existing inventory) of computing interfaces used by logical components in the environment for which a posture is being managed. The posture includes the inventory, which in turn includes any associated data and metadata for the computing interfaces reflected in the inventory.

Such an inventory may indicate, for each computing interface, data types handled by the computing interface, whether the computing interface is Internet-facing (i.e., whether the computing interface is directly exposed to the Internet, for example by being used for direct communications with the Internet), whether the computing interface enforces or requires authentication, combinations thereof, and the like. To this end, in yet a further embodiment, S250 includes analyzing the configuration parameters and traffic behavior and creating or updating the inventory based on the results of the analysis.

To determine whether a computing interface is Internet-facing, the analysis may include analyzing networking data and headers of requests, responses (e.g., HTTP headers), or both, in which the computing interface is involved in order to determine whether the computing interface is used to send requests via the Internet or to receive responses via the Internet.

In some embodiments, whether the computing interface is Internet-facing may be determined proactively by actively calling of the computing interface and checking responses to those calls. To this end, S250 may further include calling each computing interface and checking a response from each computing interface (i.e., a response to calling the computing interface) in order to determine whether the computing interface is Internet-facing. Specifically, calling each interface may be performed during a testing procedure in which a function (e.g., a lambda function) actively calls the computing interface and checks a return status code (e.g., a return status code in hypertext transfer protocol [HTTP] or HTTP secure [HTTPS]). By actively calling the computing interface, such an embodiment allows for proactively detecting contextual misconfigurations prior to runtime of the computing interface. This, in turn, allows for further mitigating harm caused by misconfigurations by allowing for identifying such misconfigurations before the computing interface is actually exposed, either directly or indirectly, to external networks and systems.

In an embodiment, the inventory may further include connections between the computing interfaces, e.g., connections based on communications between computing interfaces reflected in traffic data. Creating an inventory with such connections further allows for identifying misconfigurations or potential vulnerabilities related to other computing interfaces.

Once a portion of the posture related to a particular computing interface is detected, that posture may be utilized in order to aid in misconfiguration detection. Specifically, the posture includes a combination of relevant configuration parameters and traffic behaviors for any given computing interface. This combination of configuration parameters and traffic behaviors can eb analyzed to determine if the combination or a subset of the combination is indicative of a misconfiguration.

By proactively building a posture regardless of whether the environment is being attacked, potential contextual misconfigurations can be more readily determined prior to cyber-attacks, thereby improving security of the environment. Moreover, in addition to misconfigurations, the posture may be utilized to identify potential vulnerabilities which are not necessarily caused by misconfigurations. In this regard, it is noted that many existing solutions for remediating misconfigurations and vulnerabilities retroactively analyze traffic behavior or configuration parameters when an attack has occurred. Such existing solutions cannot identify potential exposures to cyber-attacks until after an attack is underway, and may be unable to identify the true root cause which allowed the attack to occur due to lack of context between traffic behavior and configuration parameters of APIs or other computing interfaces. Thus, managing posture with respect to computing interfaces both allows for identifying previously unidentifiable vulnerabilities and misconfigurations as well as for preemptively detecting such vulnerabilities and misconfigurations, which in turn allows for remediating issues before cyber-attacks occur.

At S260, one or more contextual misconfigurations are detected by applying contextual misconfiguration detection rules. The contextual misconfiguration detection rules define each contextual misconfiguration as a combination of one or more configuration parameters and one or more traffic behaviors such that misconfigurations are defined contextually with respect to traffic behavior relative to a give configuration.

As noted above, certain traffic behaviors may be benign in combination with certain configuration settings while being malicious in combination with other configuration settings and vice versa (i.e., certain configuration settings may be acceptable in combination with some traffic behaviors but not with others). Accordingly, defining misconfigurations as certain combinations of traffic behaviors and configuration parameters allows for accounting for the context in which the traffic behaviors of the computing interface occur. Further, certain traffic behaviors may present potential vulnerabilities in combination with certain configuration settings even when malicious activity is not occurring. Thus, contextually detecting misconfigurations as described herein allows for identifying misconfigurations before a malicious entity attempts to consume a computing interface or otherwise before an attack is underway, which in turn improves cybersecurity of the computing interface.

At S270, one or more mitigation actions are performed with respect to the detected contextual misconfigurations. In an embodiment, the mitigation actions to be performed are determined based on a type of contextual misconfiguration. To this end, S260 may include applying mitigation action determination rules defining mitigation actions to be performed for each contextual misconfiguration defined as certain combinations of traffic behaviors and configuration parameters.

The mitigation actions may include, but are not limited to, blocking traffic via misconfigured computing interfaces, blocking traffic to and from components using misconfigured computing interfaces, reconfiguring the misconfigured computing interfaces (e.g., by changing a configuration that does not require authentication to a configuration that does require authentication or by placing a web application firewall configuration in front of an API server), lowering a rate limit number, generating a notification including a recommendation to reconfigure the component using the computing interface, combinations thereof, and the like.

As a non-limiting example for contextual traffic misconfiguration detection, configuration data of an Application Programming Interface (API) and of an API management service which interact with the API is analyzed in order to determine, among other things, that the API management service is not configured to enforce authentication for the API. Further, traffic behavior of the API is analyzed to determine that, statistically, a majority of users accessing the API do so with authentication (e.g., a majority of traffic from users includes values other than null values in an “authentication credentials” field of such traffic). The contextual misconfiguration rules define the combination of a configuration parameter of an API management service indicating that authentication is not enforced along with traffic behavior indicating that the majority of traffic into the API from users includes authentication credentials as a contextual misconfiguration. Accordingly, a contextual misconfiguration is detected.

Further to the above example, the mitigation action determination rules may define one or more mitigation actions to be performed when a misconfiguration is detected based on an API management service not being configured to enforce authentication and a majority of user-based traffic including authentication credentials. As non-limiting examples, the mitigation actions for such a contextual misconfiguration may include modifying the configuration of the API management service to require an API subscription key, modifying the configuration of the API management service to require authentication, generating a notification instructing an admin to modify the configuration of the API management service to require an API subscription key or authentication, a combination thereof, and the like.

It should be noted that FIG. 2 is described with respect to identifying misconfigurations in a single computing interface merely for simplicity purposes, but that multiple instances of the process described with respect to FIG. 2 may be performed in series or in parallel such that traffic related to multiple computing interfaces can be analyzed and utilized to detect misconfigurations without departing from the scope of the disclosure.

FIG. 3 is a flowchart 300 illustrating a method for duplicating traffic according to an embodiment.

At steps S310 through S340, data is extracted from various communication protocol layers used for communication between communications interfaces. For each layer, a respective set of rules for extracting data from that layer is applied to data communicated via that layer in order to extract data from that layer. Further, some of the layers may be built based on the data extracted from other layers. As a non-limiting example, when the layers include a transport layer, an application layer, an invocation layer, and a translation layer, data extracted from the transport layer may be used in building the application layer, data extracted from the application layer may be used in building the invocation layer, and data extracted from the invocation layer may be used in building the translation layer.

The set of rules for each layer defines fields which include data to be extracted regardless of the formatting used for those fields. In a further embodiment, the rules define fields such that data extracted from those fields includes protocol-specific data (i.e., data which is only used for a particular protocol). By only extracting such protocol agnostic data and duplicating the traffic based on that protocol agnostic data, the duplicated traffic itself is protocol agnostic and can be analyzed regardless of the protocol used for the original traffic.

To this end, the set of rules for each layer may include key words or other indicators that uniquely identify headers of particular fields such that, when those indicators are included in a field, it can be determined whether to extract data from that field. Alternatively or collectively, the set of rules for each layer may include applying a machine learning model trained to identify comparable data with respect to training data for that respective layer.

The data extracted for each layer may more specifically include data needed to build higher layers, metadata utilized for use in duplicating the traffic, both, and the like. The set of rules for each layer may further define which fields include data for building higher layers and which fields include metadata.

At S310, data is extracted from a transport layer. Extracting the data from the transport layer may include, but is not limited to, reconstructing communications according to the Transmission Control Protocol (TCP) or other transport layer protocol. To this end, S310 may further include segmenting traffic into different sessions and ordering the packets. The data is extracted from the ordered packets.

At S320, data is extracted from an application layer. Extracting the data from the application layer may include, but is not limited to, parsing Hypertext Transfer Protocol (HTTP) packets. To this end, S320 may further include splitting the packets into sessions, each session made of a request-response pair.

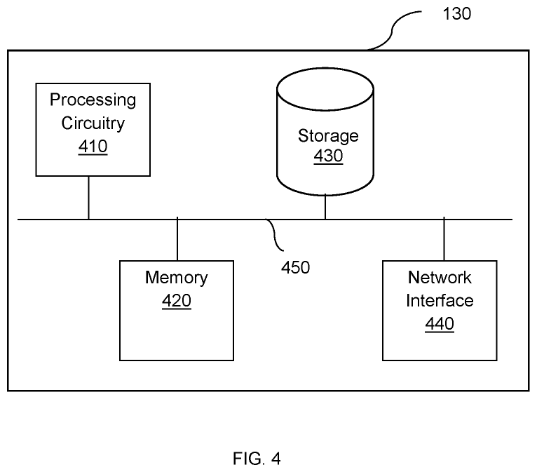

In an embodiment where the system performing traffic duplication is not deployed in line between communications interfaces or otherwise when the system performing traffic duplication does not have access to the raw communications data (e.g., when the system is deployed out of line and receives incomplete communications data from an API gateway that is deployed in line such that the system does not have access to the complete set of request-response pairs), duplicating the traffic may further include performing a full session reconstruction as described further below with respect to FIG. 4. Such a full session reconstruction provides the request-response pairs needed for application layer data extraction.

At S330, data is extracted from an invocation layer. The invocation layer is a layer which includes invocation of functions or paths by a higher layer (e.g., the translation layer). In an embodiment, S330 includes identifying invocations of functions or paths.

Whether to identify invocations of functions or paths may be determined by identifying a type of communication framework (e.g., a type of remote procedure call or software architectural style) used for communications. To this end, the set of rules applied to the invocation layer may further include rules for identifying the type of communication framework and rules to be applied to communications according to different communication frameworks. Example communication frameworks may include, but are not limited to, Representational state transfer (REST), Simple Object Access Protocol (SOAP), gRPC Remote Procedure Calls (gRPC), GraphQL, and the like.

As a non-limiting example, for communications according to gRPC, the extracted data may include the name of a function that is invoked by the Protocol Buffers layer (i.e., the translation layer for gRPC). Such function name data may proceed to be used to build the Protocol Buffers layer. As another non-limiting example, for communications according to REST (which does not involve invoking functions), the extracted data may include the name of a path that is invoked by the translation layer.

At S340, data is extracted from a translation layer. The translation layer may be responsible for translating data by structuring the data into a particular format for storage or other subsequent use. Like for the invocation layer, the data may be stored in a protocol-specific format that varies depending on the communication framework being utilized and, therefore, the rules for extracting data from the translation data may include different sets of rules for different communication frameworks.

As a non-limiting example for the layers noted above, when a remote procedure call used for communications between two computing interfaces is gRPC, the transport layer is a TCP layer, the application layer is a HTTP 2 layer, the invocation layer is a gRPC layer, and the translation layer may be a Protocol Buffers Layer.

At S350, the traffic is duplicated based on the data extracted at each layer as described above with respect to S310 through S340. In an embodiment, the traffic is duplicated by converting the extracted data into a unified data modeling format. The unified data modeling format includes data related to the traffic which is protocol-agnostic, that is, the data is formatted such that subsequent use and processing of the data does not depend on the protocols which are used to communicate the data.

It should be noted that the extraction of data described above with respect to S310 through S340 includes extracting data from specific layers, but that the disclosed embodiments are not necessarily limited to these specific layers. In at least some other embodiments, data may be extracted from more or different layers than the layers mentioned above.

FIG. 4 is an example schematic diagram of a misconfiguration detector 140 according to an embodiment. The misconfiguration detector 140 includes a processing circuitry 410 coupled to a memory 420, a storage 430, and a network interface 440. In an embodiment, the components of the misconfiguration detector 140 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk—read only memory (CD-ROM), Digital Versatile Disks (DVDs), or any other medium which can be used to store the desired information.

The network interface 440 allows the misconfiguration detector 140 to communicate with, for example, the internal services 120, the external services 130, the admin device 150 combinations thereof, and the like.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for traffic-based misconfiguration detection, comprising:
identifying at least one configuration parameter based on configuration data related to a computing interface;
determining at least one traffic behavior based on traffic data of traffic to and from the computing interface; and
detecting at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior.

2. The method of claim 1, further comprising:
performing at least one mitigation action with respect to the computing interface based on the identified misconfiguration.

3. The method of claim 2, wherein each contextual misconfiguration rule is associated with at least one predetermined mitigation action, further comprising:
determining the at least one mitigation action to be performed based on the detected at least one misconfiguration based on the predetermined mitigation actions associated with the contextual misconfiguration rules.

4. The method of claim 1, wherein the computing interface is a first computing interface, further comprising:
managing a cybersecurity posture of an environment in which the first computing interface is deployed by creating an inventory of second computing interfaces used for communications in the environment based on the identified at least one configuration parameter and the determined at least one traffic behavior, wherein the at least one misconfiguration is detected based further on the inventory.

5. The method of claim 4, wherein the inventory indicates, for each of the first and second computing interfaces, at least one of: data types handled by the computing interface, whether the computing interface is Internet-facing, whether the computing interface enforces authentication, and whether the computing interface requires authentication.

6. The method of claim 5, wherein creating the inventory further comprises:
determining whether the first computing interface is Internet-facing by analyzing networking data and headers of requests and responses involving the first computing interface; and
adding an entry to the inventory based on the determination of whether the first computing interface is Internet-facing.

7. The method of claim 5, wherein creating the inventory further comprises:
calling each computing interface;
checking a response to calling each computing interface in order to determine whether the called computing interface is Internet-facing; and
adding an entry to the inventory based on the determination of whether the first computing interface is Internet-facing.

8. The method of claim 1, wherein the traffic data includes duplicated traffic created based on data extracted from a communications session by building at least one of a plurality of communication layers based on data extracted from other layers of the plurality of communication protocol layers.

9. The method of claim 1, wherein at least a portion of the configuration data related to the computing interface is determined based on at least one computing component to which the computing interface is exposed.

10. A non-transitory computer readable medium having stored thereon instructions for causing a processing circuitry to execute a process, the process comprising:
identifying at least one configuration parameter based on configuration data related to a computing interface;
determining at least one traffic behavior based on traffic data of traffic to and from the computing interface; and
detecting at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior.

11. A system for contextual misconfiguration detection, comprising:
a processing circuitry; and
a memory, the memory containing instructions that, when executed by the processing circuitry, configure the system to:
identify at least one configuration parameter based on configuration data related to a computing interface;
determine at least one traffic behavior based on traffic data of traffic to and from the computing interface; and
detect at least one misconfiguration by applying a plurality of contextual misconfiguration rules to the identified at least one configuration parameter and the determined at least one traffic behavior, wherein each contextual misconfiguration rule defines a respective misconfiguration as a combination of at least one predetermined configuration parameter and at least one predetermined traffic behavior.

12. The system of claim 11, wherein the system is further configured to:
perform at least one mitigation action with respect to the computing interface based on the identified misconfiguration.

13. The system of claim 12, wherein each contextual misconfiguration rule is associated with at least one predetermined mitigation action, wherein the system is further configured to:
determine the at least one mitigation action to be performed based on the detected at least one misconfiguration based on the predetermined mitigation actions associated with the contextual misconfiguration rules.

14. The system of claim 11, wherein the computing interface is a first computing interface, wherein the system is further configured to:
manage a cybersecurity posture of an environment in which the first computing interface is deployed by creating an inventory of second computing interfaces used for communications in the environment based on the identified at least one configuration parameter and the determined at least one traffic behavior, wherein the at least one misconfiguration is detected based further on the inventory.

15. The system of claim 14, wherein the inventory indicates, for each of the first and second computing interfaces, at least one of: data types handled by the computing interface, whether the computing interface is Internet-facing, whether the computing interface enforces authentication, and whether the computing interface requires authentication.

16. The system of claim 15, wherein the system is further configured to:
determine whether the first computing interface is Internet-facing by analyzing networking data and headers of requests and responses involving the first computing interface; and
add an entry to the inventory based on the determination of whether the first computing interface is Internet-facing.

17. The system of claim 15, wherein the system is further configured to:
call each computing interface;
check a response to calling each computing interface in order to determine whether the called computing interface is Internet-facing; and
add an entry to the inventory based on the determination of whether the first computing interface is Internet-facing.

18. The system of claim 11, wherein the traffic data includes duplicated traffic created based on data extracted from a communications session by building at least one of a plurality of communication layers based on data extracted from other layers of the plurality of communication protocol layers.

19. The system of claim 11, wherein at least a portion of the configuration data related to the computing interface is determined based on at least one computing component to which the computing interface is exposed.
